(19) United States
(12) Patent Application Publication
(10) Pub. No.: US 2023/0060109 A1
(43) Pub. Date: Feb. 23, 2023

(54) SYSTEMS AND METHODS FOR RENDERING CANNABIS WASTE FOR COMPOSTING

(71) Applicant: Gaiaca, LLC, Gonzales, CA (US)

(72) Inventors: Jonathan LEE, Monterey, CA (US); Garrett RODEWALD, Pacific Grove, CA (US)

(73) Assignee: Gaiaca, LLC, Gonzales, CA (US)

(21) Appl. No.: 18/045,270

(22) Filed: Oct. 10, 2022

Related U.S. Application Data
(63) Continuation-in-part of application No. 17/659,919, filed on Apr. 20, 2022, now Pat. No. 11,484,920.
Application No. 17/659,919 is a continuation of application No. 17/075,646, filed on Oct. 20, 2020, now Pat. No. 11,318,510.
Application No. 17/075,646 is a continuation-in-part of application No. 16/198,747, filed on Nov. 21, 2018, now Pat. No. 10,876,061.
(60) Provisional application No. 62/590,204, filed on Nov. 22, 2017.

(51) Int. Cl. B09B 3/00; A62D 3/40; B02C 18/00; A62D 101/28

(52) U.S. Cl. CPC B09B 3/00; A62D 3/40; B02C 18/0092; A62D 2101/28

(57) ABSTRACT

Systems and methods for composting cannabis-related waste materials are provided. The method may include obtaining a plurality of cannabis-related waste materials, physically altering, e.g., pulverizing, the cannabis-related waste materials to form a feedstock suitable for composting, and transforming the feedstock into compost. For example, the feedstock may be composted via at least one of a windrow method, aerated static pile (ASP), in-vessel digestion, or vermicomposting. The obtained cannabis-waste materials may have a predetermined ratio of carbon to nitrogen, and the physically altered cannabis-related waste materials may be altered to smaller particle sizes suitable as a pre-compost. For example, the physically altered cannabis-related waste materials may be unrecognizable and unusable, in compliance with local and state regulations.

### CROSS-REFERENCE TO RELATED APPLICATIONS

This application is a continuation-in-part of U.S. patent application Ser. No. 17/659,919, filed Apr. 20, 2022, which is a continuation of U.S. patent application Ser. No. 17/075,646, filed Oct. 20, 2020, now U.S. Pat. No. 11,318,510, which is a continuation-in-part of U.S. patent application Ser. No. 16/198,747, filed Nov. 21, 2018, now U.S. Pat. No. 10,876,061, which claims the benefit of priority of U.S. Provisional Application Ser. No. 62/590,204, filed Nov. 22, 2017, the entire contents of each of which are incorporated herein by reference. This application is also related to U.S. Pat. No. 11,179,757, the entire contents of which are incorporated herein by reference.

### FIELD OF USE

The present disclosure is directed to systems and methods for rendering cannabis-related waste materials, e.g., for composting.

### BACKGROUND

The cannabis industry, e.g., medical and recreational, encompasses a variety of business such as grow operations, product manufacturers, distributors, dispensaries, and testing laboratories. As the cannabis industry continues to grow, the steps of harvesting and processing cannabis, e.g., marijuana, for extraction, and infusion of products (which include, but are not limited to: edibles, e.g., cookie, brownie, candy, chocolate, gummy, beverage, soda, dessert, caramel, mint, pill, hot sauce, dried fruit, olive oil, and cooking oil; cannabis extract/concentrate; tincture/sublingual strips; topical, e.g., balm, salve, lotion, oil, and bath bomb; joints/blunts/cigarettes; vaporizers, and cannabis applicators) generate large amounts of byproducts and waste. Cannabis is a Schedule 1 Controlled Substance, and therefore must adhere to the Federal Controlled Substances Act.

Accordingly, cannabis-related waste materials including cannabis waste (i.e. cannabis plant material), cannabis-infused products, mixed packaging, manufacturing byproducts, grow medium, contaminated disposables, and contaminated cannabis waste must be disposed of in compliance with applicable state laws and regulations. Specifically, cannabis waste may still contain regulated substances, e.g., tetrahydrocannabinol (THC), the chemical responsible for the medical effects of cannabis, and thus must be disposed of in compliance with applicable state laws and regulations. Cannabis waste includes cannabis plant material/biomass such as roots, stalks, stems, leaves, and flowers of the cannabis plant. Cannabis-related wastes materials includes cannabis-infused products with mixed packaging, e.g., glass, plastic, fiber, and metal, manufacturing byproducts, e.g., plant fats, waxes, lipids, and terpenes, non-compostable grow mediums such as rock-wool, contaminated disposables, e.g., personal protective equipment such as nitrile/rubber gloves, batteries, cellulose papers, filters, containers, utensils, and lab ware, and contaminated cannabis waste, e.g., cannabis plant material/biomass, e.g., roots, stalks, stems, leaves, and flowers of the cannabis plant, having high levels of contaminants, e.g., pesticides, fertilizers, solvents (alcohols-based, hydrocarbon-based), chemicals, reactants, and heavy metals.

Currently, 33 states have legalized medical cannabis. Although the Federal Controlled Substances Act controls the substance, individual states are responsible for handling the cultivation, manufacturing, storage, and disposal of cannabis waste. For example, California state law requires that medical and recreational cannabis waste must be made unusable and unrecognizable prior to leaving the licensed premises. Similarly, Illinois state law requires dispensaries to destroy cannabis waste in order to render it unusable, stating an “allowable method to render cannabis waste unusable is by grinding and incorporating the cannabis waste with other ground materials so the resulting mixture is at least 50% non-cannabis waste by volume,” and Washington state law recites “[t]he allowable method to render marijuana plant waste unusable is by grinding and incorporating the marijuana plant waste with other ground materials so the resulting mixture is at least fifty percent nonmarijuana waste by volume.” As the cannabis industry highly impacts our environment, these cannabis disposal laws are essential for the protection of public health and the environment.

Typically, cannabis waste is mixed with either compostable waste or non-compostable waste to render it unusable and unrecognizable in accordance with state laws and regulations. Suggested compostable waste currently used includes food waste, green waste, green waste, and vegetable based grease and oils, and suggested non-compostable waste currently used includes paper waste, cardboard waste, plastic waste, and soil. However, these compostable and non-compostable wastes may be costly, and may not effectively mix with the grinded cannabis waste such that the result is deemed unusable and unrecognizable.

In addition, cannabis-related wastes materials must also be disposed of according to state and local laws and regulations, and typically are disposed of in an unsustainable manner.

In view of the foregoing drawbacks of previously known systems and methods, there exists a need for more efficient and cost-effective systems and methods for the rendering and disposal of cannabis-related waste materials including cannabis plant material, as well as systems and methods for ensuring proper rendering of the cannabis-related waste materials in compliance with local regulations.

### SUMMARY

The present disclosure overcomes the drawbacks of previously-known systems and methods by providing efficient and cost-effective systems and methods for rendering cannabis-related waste materials including cannabis plant material for disposal in accordance with state laws and regulations, as well as for other uses such as composting. In accordance with one aspect of the present disclosure, a method for composting cannabis-related waste materials is provided. The method may include obtaining a plurality of cannabis-related waste materials, physically altering, e.g., pulverizing, the plurality of cannabis-related waste materials to form a pre-compost blend, such that the physically altered cannabis-related waste materials are altered to smaller particle sizes suitable as a pre-compost, and transforming the pre-compost blend into compost. Accordingly, the pre-compost blend may be feedstock suitable for composting. In some embodiments, physically altering the plurality of cannabis-related waste materials to form the pre-compost blend may include physically altering the plurality of cannabis-related waste materials such that the physically altered cannabis-related waste materials are unrecognizable and unusable.

Obtaining the plurality of cannabis-related waste materials may include obtaining a mix of cannabis-related waste materials comprising a predetermined ratio of carbon to nitrogen, e.g., 25-30:1. The plurality of cannabis-related waste materials may include at least one of cannabis plant material, cannabis-infused products, mixed packaging, manufacturing byproducts, grow medium, or contaminated disposables. Moreover, the compost may be configured to be used as a nutrient-rich fertilizer or a soil amendment. For example, the method further may include adding one or more organic bulking agents to the compost to form a finished soil product.

In some embodiments, transforming the pre-compost blend into compost may include transforming the pre-compost blend into compost via a windrow method. For example, the windrow method may include laying the pre-compost blend in one or more rows sized and shaped to generate sufficient heat and facilitate maintenance of a temperature within a predetermined range, while permitting oxygen to flow to a core of the one or more rows of pre-compost blend, and increasing a moisture content of the one or more rows of pre-compost blend and/or turning the one or more rows of pre-compost blend to maintain the temperature within the predetermined range over a predetermined period of time to transform the one or more rows of pre-compost blend into compost.

Additionally or alternatively, transforming the pre-compost blend into compost may include transforming the pre-compost blend into compost via an aerated static pile (ASP) method. For example, the ASP method may include: laying a plenum layer of coarse material on a non-permeable pad, the pad including a perforated manifold configured to deliver air uniformly across the pad; laying the pre-compost blend on top of the plenum layer; laying a biofiltration layer on top of the pre-compost blend to facilitate maintenance of a temperature within a predetermined range; and increasing a moisture content of the pre-compost blend and/or aerating the pre-compost blend via the manifold to maintain the temperature within the predetermined range over a predetermined period of time to transform pre-compost blend into compost.

Additionally or alternatively, transforming the pre-compost blend into compost may include transforming the pre-compost blend into compost via in-vessel digestion. For example, in-vessel digestion may include: adding a plenum layer of coarse material within a composting reactor having complex microbial communities adapted to digest the pre-compost blend via an anaerobic process, such that the plenum layer is configured to facilitate uniform distribution of airflow and proper drainage of the composting reactor; adding the pre-compost blend on top of the plenum layer within the composting reactor, such that there is a predetermined amount of head space within the composting reactor; maintaining a temperature within a predetermined range over a first predetermined period of time until the complex microbial communities transform the pre-compost blend into a digestate; and curing the digestate for a second predetermined period of time to transform the digestate into compost. The compost may be configured to be used as a nutrient-rich fertilizer, as animal bedding, to make building materials, irrigate crops, or as a feedstock to create horticulture products comprising at least one of soil amendments, peat moss replacement, or plant pots. The method further may include draining leachate from the composting reactor, such the leachate may be configured to be mixed with water and used as a nutrient-rich liquid fertilizer. In addition, the method further may include capturing biogas from the composting reactor, such that the biogas may be configured to be used to produce electricity, heat, vehicle fuel, or renewal natural gas, or as a feedstock to produce bioproducts. The method further may include passing the biogas through a solution of liquid boric acid prior to capturing the biogas from the composting reactor.

Additionally or alternatively, transforming the pre-compost blend into compost may include transforming the pre-compost blend into compost via vermicomposting. For example, vermicomposting may include: preparing worm bedding within an opaque bin comprising one or more holes, the one or more holes covered with a screen material; adding the pre-compost blend to the opaque bin; adding worms to the pre-compost blend, such that the worms are adapted to consume microbes that break down the pre-compost blend and create compostable castings; and continually replenishing the worm bedding and keeping the worm bedding moist for a predetermined period of time to transform the pre-compost blend into compostable castings. The compostable castings may be configured to be used as a nutrient-rich fertilizer or a soil amendment. The method further may include draining worm tea from opaque bin, such that the worm tea may be configured to be mixed with water and used as a nutrient-rich liquid fertilizer. Moreover, the method may include transferring contents within the opaque bin on top of a lid of a harvest bin, the lid having one or more holes; placing the harvest bin in direct sunlight, thereby causing the worms to burrow through the one or more holes into the harvest bin; and harvesting the compostable castings from the contents on top of the lid of the harvest bin.

The method further may include obtaining one or more additional feedstock materials, and blending the one or more additional feedstock materials with the plurality of cannabis-related waste materials to form a feedstock blend. Accordingly, physically altering the plurality of cannabis-related waste materials to form the pre-compost blend may include physically altering the feedstock blend, such that the physically altered cannabis-related waste and one or more additional feedstock materials are altered to smaller particle sizes suitable as a pre-compost. The one or more additional feedstock materials may include at least one of organic materials, yard waste, landscaping debris, newspaper, paper products, cardboard, fiber, foods, e.g., fruits, vegetables, grains, breads, nuts, eggshells, coffee, tea, or seaweed, agricultural processing waste, animal and plant materials, manure, biosolids, solid waste, mushroom mycelium, or grape pomace.

Moreover, the method further may include separating the obtained plurality of cannabis-related waste materials into compostable organics and non-compostable inorganics. Accordingly, physically altering the plurality of cannabis-related waste materials to form the pre-compost blend may include physically altering the compostable organics to form the pre-compost blend. The method further may include treating, recycling, or disposing the non-compostable inorganics. The non-compostable inorganics may include at least one of plastic, metal, glass, gloves, containers, utensils, hazardous chemicals, vape cartridges, batteries, lamps, or lights. In addition, the method may include screening the compost via at least one of a mechanical trommel, star, orbital, grizzly, disc screen, or flat/deck screen.

### BRIEF DESCRIPTION OF THE DRAWINGS

FIG. 1 is a flow chart illustrating the steps of an exemplary method for rendering cannabis waste in accordance with the principles of the present disclosure.

FIG. 2 is a flow chart illustrating the steps of an exemplary method for rendering cannabis-related waste in accordance with the principles of the present disclosure.

FIG. 3 is a schematic of a mobile rendering vehicle for rendering cannabis-related waste constructed in accordance with the principles of the present disclosure.

FIG. 4 is a flow chart illustrating the steps of an exemplary method for rendering cannabis-related waste via a mobile rendering vehicle.

FIGS. 5A to 5F illustrates various steps of an exemplary method for rendering cannabis-related waste via a mobile rendering vehicle.

FIG. 6 illustrates a sample Certificate of Destruction.

FIG. 7 is a flow chart illustrating the steps of an exemplary method for composting cannabis-related waste in accordance with the principles of the present disclosure.

FIG. 8 illustrates a windrow composting system constructed in accordance with the principles of the present disclosure.

FIG. 9 illustrates an aerated static pile composting system constructed in accordance with the principles of the present disclosure.

FIG. 10 illustrates an in-vessel digestion composting system constructed in accordance with the principles of the present disclosure.

FIG. 11 illustrates a vermicomposting system constructed in accordance with the principles of the present disclosure.

### DETAILED DESCRIPTION

Cannabis-related waste materials including cannabis waste (i.e. cannabis plant material), cannabis-infused products, mixed packaging, manufacturing byproducts, grow medium, contaminated disposables, and contaminated cannabis waste, must be disposed of in compliance with the governing state laws and regulations, e.g., by rendering it unusable and unrecognizable, for example, as described in U.S. patent. Nos. 11,318,510 and 10,876,061 to Lee, the entire contents of which are incorporated herein by reference. By blending grinded cannabis plant material with at least equal parts of grinded non-cannabis material, wherein at least a portion of the non-cannabis material includes wood shavings, the resulting pre-compost blend is unusable and unrecognizable. In accordance with the principles of the present disclosure, the pre-compost blend resulting from the methods described herein may be revitalized into rich compost, e.g., via windrow (turned), aerated static pile (ASP), in-vessel digestion, vermicomposting, or the Bokashi method, as described in further detail below.

In addition, cannabis-related waste materials may be transformed into refuse-derived fuel by pulverizing, heating, sterilizing, denaturing, and cooling the cannabis-related waste materials. In accordance with the principles of the present disclosure, the refuse-derived fuel may be pelletized, compressed, or vacuum-packed-and-sealed, to be used as a renewable energy source.

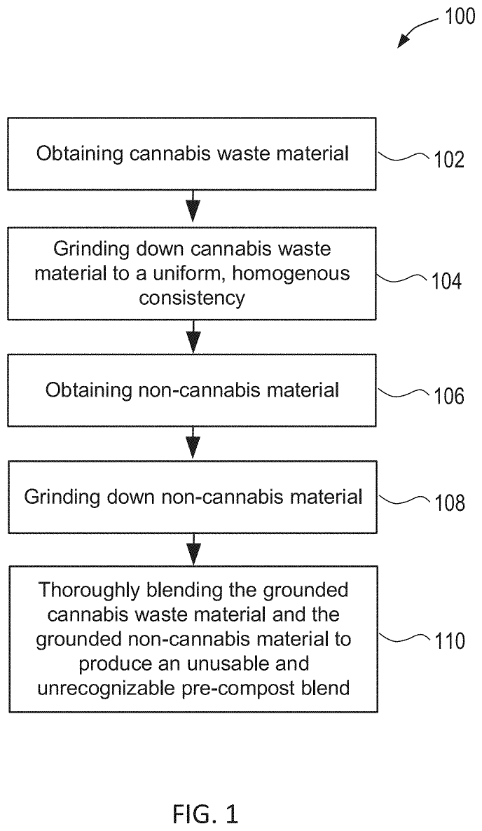

Referring to FIG. 1, exemplary method 100 for rendering cannabis waste-related materials, including cannabis waste is described. At step 102, cannabis waste-related material, e.g., cannabis waste, is obtained. Cannabis waste may include cannabis plant material/biomass such as roots, stalks, flower, leaves, and stems of the cannabis plant. The roots, e.g., root mass or root ball, is the fibrous underground portion of the cannabis plant, which is rich in Carbon and often times obtained with grow medium, e.g., coco fiber, peat moss, clay, soil, etc., used to cultivate the cannabis plant. The stalks are the fibrous portion of the cannabis plant, and is rich and Carbon and often times used to produce hemp. The flower, e.g., the bud, may be considered the most valuable portion of the cannabis plant, is rich in Nitrogen, and may be used to extract large amounts of THC and other valuable compounds. The leaves are the leafy, green portion of the cannabis plant, is rich in Nitrogen, and may be used to extract small amounts of THC and other valuable compounds. Biomass includes portions of the cannabis plant, e.g., leaves and flower, that have undergone manufacturing and have had THC and other valuable compounds extracted therefrom, and is rich in Nitrogen. Cannabis is considered a “wet green” material, high in Nitrogen.

At step 104, the cannabis waste-related material may be physically altered such as by, for example, pulverizing, compacting, crushing, grinding, shredding, chipping, mixing, blending, burning (combustion), incinerating, carbonizing, gasifying, stabilizing, vitrifying, denaturing, dissolving, and/or saturating/spraying the cannabis waste material. As should be understood, these examples of physical alteration are not mutually exclusive. For example, crushing may include grinding, mixing, and/or blending, etc. In some embodiments, the cannabis waste material may be grinded down, e.g., via a commercial wood chipper or shredder if the cannabis waste material includes hard/rigid cannabis plant material, or a commercial grinder if the cannabis waste material includes soft/malleable cannabis plant material, to a uniform, homogenous consistency. Hard/rigid cannabis plant materials include stalks, stems, sticks, branches, etc., and soft/malleable cannabis plant materials include flowers, buds, leaves, trimmings, etc. The particles of the grinded cannabis waste material may have sizes ranging from dust to a grain of rice. At this stage, the cannabis waste-related material may be sufficiently rendered unusable and unrecognizable.

In addition, the grinded cannabis waste material may be wetted with approximately 1 to 5 gallons of liquid, e.g., water, per approximately 55 gallons of the grinded cannabis waste material, e.g., 1.8%-9.1% water/material ratio, to reduce or prevent dust release. The resulting grinded cannabis waste material/liquid mixture is merely damp, e.g., not a sludge or slurry, and is able to retain its water composition in a solid form. The liquid in the mixture also reduces dust/release of airborne contaminants, provides odor control, as well as aids in the mixing process.

Additionally or alternatively, the cannabis waste-related material may be physically altered via chemical alteration, e.g., saturating the cannabis waste-related material with a liquid solution. For example, the cannabis waste-related material may be saturated/sprayed with a dye, pigment, acid wash, corrosive, caustic, neutralizer, denaturant, solvent, sanitizer, paint, oil, and/or water to render the cannabis waste-related material unusable and unrecognizable.

Optionally, at step 106, non-cannabis material, e.g., an organic compostable material, may be obtained. At least a portion of the non-cannabis material includes wood material, e.g., wood shavings. Different types of wood shavings include wood chips, saw dust, bark, branches, limbs, trunks, stumps, heartwood, sapwood, etc. Wood shavings are a natural, organic material this is easily wetted and retains moisture well. Wood shavings are already broken down, making them easier to grind down further and to mix with the cannabis waste material. In addition, wood shavings provide dark pigments which is similar to that of aged cannabis waste materials, which makes the cannabis waste material even more unrecognizable upon blending. Wood shavings are also light-weight, inexpensive, and readily available. Wood shavings are considered a “dry brown” material, high in Carbon. In addition to, or alternatively, the non-cannabis material may include at least one of corn starch, vegetable starch, polymeric carbohydrate, natural adhesives, dextrin, natural resins, casein (i.e., milk protein), hide-based animal glues, bioadhesives, flour and water (heated), albumen (blood protein), natural wood lignin, organic polymers, or gelatin.

At least another portion of the non-cannabis material may include at least one of yard debris, food waste, coffee grounds, tea leaves, leaves, flowers, seeds, grass, animal feces/manure, soil, vegetables, fruits, pericarp (meat around the seed of a fruit), caryopsis (cereal grain fruit, e.g., wheat, barley, rice), marine mollusk shells, marine algae, hair, insect parts, natural and synthetic fibers, etc.

Optionally, at step 108, the non-cannabis material is grinded down, e.g., via a wood chipper/shredder. The particles of the grinded non-cannabis material may have sizes ranging from dust to a grain of rice. In one embodiment, the same grinder/shredder used to grind down the cannabis waste material may be used to grind down non-cannabis material. In addition, the cannabis waste material and non-cannabis material may be grinded down simultaneously, e.g., using the same grinder/shredder at the same time. For example, the cannabis waste material and non-cannabis material may be grinded down using an industrial multi-purpose grinder provided by JWC Environmental®. In this embodiment, step 104 and step 108 may be performed simultaneously such that the cannabis waste material and non-cannabis material are grinded down and blended simultaneously.

In addition, the grinded non-cannabis material may be wetted with approximately 1 to 5 gallons of liquid, e.g., water, per approximately 55 gallons of the grinded non-cannabis material, e.g., 1.8%-9.1% water/material ratio, to reduce or prevent dust release. The resulting grinded non-cannabis material/liquid mixture is merely damp, e.g., not a sludge or slurry, and is able to retain its water composition in a solid form.

Optionally, at step 110, the grinded cannabis waste material and the grinded non-cannabis material are thoroughly blended, e.g., via a commercial soil mixer, such that the blended cannabis waste material and the grinded non-cannabis material completely mixed as will be understood by a person of ordinary skill in the art. For example, the grinded cannabis waste material may be thoroughly blended with at least equal parts of the grinded non-cannabis material in compliance with various state laws and regulations. The grinded cannabis waste material and the grinded non-cannabis material may be thoroughly blended for a time period of at least approximately two minutes, or until thoroughly blended to produce an unusable and unrecognizable pre-compost blend. As will be understood by a person having ordinary skill in the art, if step 104 and step 108 are performed simultaneously such that the cannabis waste material and non-cannabis material are grinded down and blended simultaneously, there is no need to perform step 110 as the grinded cannabis waste material and the grinded non-cannabis material will already be thoroughly blended.

The pre-compost blend is “unrecognizable” in that the cannabis plant material is rendered indistinguishable from any other plant material as will be understood by a person of ordinary skill in the art. The pre-compost blend is “unusable” in that the cannabis waste material generated from cultivation, manufacturing, retail, testing lab, or distribution has no further use or value in that particular process, such that is not attractive or desirable for use for, e.g., smoking, eating, manufacturing, packaging, etc. Additionally, unusable cannabis waste material that has been altered in its physical and/or chemical state, has reduced or no medical and/or psychoactive properties compared to those of unaltered cannabis product.

In addition, the pre-compost blend may be wetted with approximately 1 to 5 gallons of liquid, e.g., water, per approximately 55 gallons of the pre-compost blend, e.g., 1.8%-9.1% water/material ratio, to reduce or prevent dust release. The resulting pre-compost blend/liquid mixture is merely damp, e.g., not a sludge or slurry, and is able to retain its water composition in a solid form. The pre-compost blend will also begin to break down more quickly if damp.

In addition, the pre-compost blend may be further rendered into compost via, e.g., windrow (turned), aerated static pile (ASP), in-vessel digestion, vermicomposting, or the Bokashi method as will be understood by a person having ordinary skill in the art. Compost feedstock requires a specific blend of nitrogen-rich (“green”) material and carbon-rich (“brown”) material. The high Carbon content of the wood material and the high Nitrogen content of the cannabis waste material results in a high quality pre-compost blend for creating compost. Therefore, the pre-blend compost may be revitalized into compost, e.g., ready-to-use-soil, by using cannabis waste materials as a feedstock in composting, which is the process in which plant, food, and other organic matter are decomposed or recycled into a new form, rich in nutrients and beneficial organisms. Cannabis waste is theorized to be a suitable feedstock, as it is rich in both material types.

As will be understood by a person having ordinary skill in the art, other suitable mixers and grinders include cement mixers, soil mixers, soil batch mixers, conical mixers, paddle mixers, mortar mixers, drum and barrel mixers, grain mixers, compost screeners, rototillers, commercial food/culinary mixers, rotor bar mixers, dispersion mixers, soil grinders, feed grinders, grain grinders, commercial food/culinary grinders, meat grinders, and wood grinder, etc.

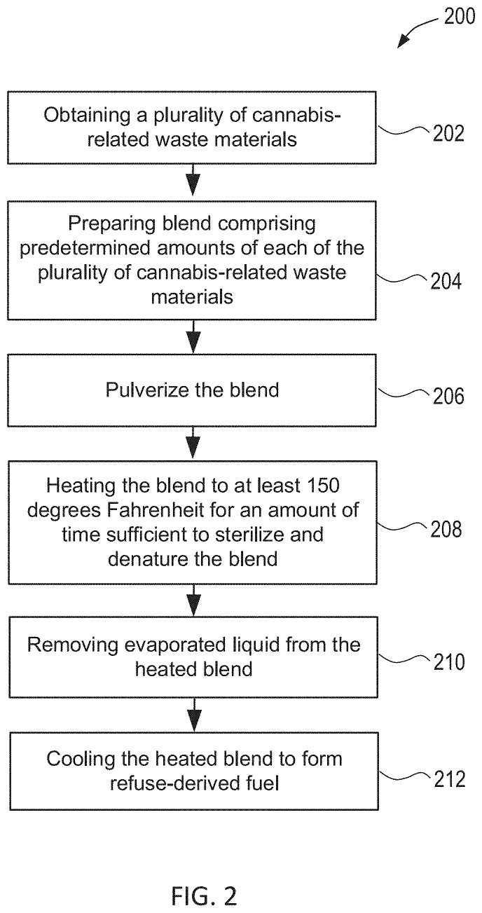

Unlike cannabis plant material, not all cannabis-related waste materials are compostable. Thus, referring now to FIG. 2, exemplary method 200 for rendering cannabis-related waste materials is described. At step 202, a plurality of cannabis-related waste materials is obtained, e.g., collected from cannabis operators such as testing labs, distributors, dispensaries, microbusinesses, cannabis cultivators, nurseries, processors, and manufacturers of cannabis products. Cannabis-related waste materials may include cannabis waste (i.e. cannabis plant material), cannabis-infused products, mixed packaging, manufacturing byproducts, grow medium, contaminated disposables, and contaminated cannabis waste. For example, cannabis-infused products include: edibles, e.g., cookie, brownie, candy, chocolate, gummy, beverage, soda, dessert, caramel, mint, pill, hot sauce, dried fruit, olive oil, and cooking oil; cannabis extract/concentrate; tincture/sublingual strips; topical, e.g., balm, salve, lotion, oil, and bath bomb; joints/blunts/cigarettes; vaporizers, and cannabis applicators. Mixed packaging includes glass, plastic, fiber, and metal. Manufacturing byproducts include plant fats, waxes, lipids, and terpenes. Non-compostable grow mediums include rock-wool. Contaminated disposables (i.e., disposable items contaminated with cannabis constituents such as cannabinoids) include personal protective equipment such as nitrile/rubber gloves, cellulose papers, filters, containers, utensils, and lab ware. Contaminated cannabis waste includes cannabis plant material/biomass, e.g., roots, stalks, stems, leaves, and flowers of the cannabis plant, having high levels of contaminants, e.g., pesticides, fertilizers, solvents (alcohols-based, hydrocarbon-based), chemicals, reactants, and heavy metals, making the cannabis waste unsuitable for compost. The cannabis-infused products may be removed from its packaging prior to processing.

At step 204, a blend of the plurality of cannabis-related waste materials is prepared using a predetermined amount of each of the cannabis-related waste materials obtained. For example, the blend may include, 20% cannabis plant material, 20% cannabis-infused products, 20% mixed packaging, 20% grow medium, 20% contaminated disposables. As will be understood by a person having ordinary skill in the art, the amount of each of the plurality of cannabis-related waste materials obtained may be selected to control moisture content, liquid state (solid or liquid), or organic or inorganic content, to create a more balanced, efficient mixture for processing. Prior to preparing the blend, the plurality of cannabis-related waste materials obtained may be organized based on preselected attributes of each of the plurality of cannabis-related waste materials, e.g., cannabis plant material, cannabis-infused products, mixed packaging, manufacturing byproducts, grow medium, contaminated disposables, and contaminated cannabis waste.

At step 206, the blend is physically altered, e.g., pulverized, such that the blend is unrecognizable and unusable. For example, the blend may be loaded into a sealed chamber of a thermokinetic waste converter having a high-speed rotor designed to pulverize the blend. The blend may be loaded into the thermokinetic waste converter either manually or automatically depending on the size of the converter. Upon operation of the thermokinetic waste converter, the high-speed rotor and steel teeth within the thermokinetic waste converter pulverizes the blend, e.g., to the size of a grain of rice.

Optionally, at step 208, the pulverized blend is heated to at least 150 degrees Fahrenheit, e.g., at least 200 or 300 degrees Fahrenheit. Specifically, the high-speed rotor of the thermokinetic waste converter is designed to convert kinetic energy to thermal energy to heat the blend via friction. Water in the form of hot steam may be introduced into the sealed chamber of the thermokinetic waste converter to achieve higher temperatures, e.g., at least 300 degrees Fahrenheit. The blend is held within the sealed chamber of the thermokinetic waste converter and heated for, e.g., up to 30 minutes, such that the high temperature within the sealed chamber of the thermokinetic waste converter sterilizes and denatures the blend. For example, the high temperature sterilizes the blend such that any pathogens and biohazards are removed from the blend. In addition, the high temperature denatures the blend by breaking down cannabis constituents such as cannabinoids including tetrahydrocannabinol in the blend. Due to the high temperatures within the sealed chamber of the thermokinetic waste converter during heating, liquid evaporated from the heated blend may be collected at step 210. For example, the liquid may be collecting into a separate holding container for later disposal/treatment. As will be understood by a person having ordinary skill in the art, liquid evaporated from the heated blend may be collected during the heating step of 208.

Optionally, at step 212, the sterilized and denatured blend is cooled to a suitable temperature within the sealed chamber of the thermokinetic waste converter. Steps 206, 208, and 212 may all occur within the sealed chamber of the thermokinetic waste converter, thus avoiding having to transfer the blend during processing. The result of steps 206, 208, 210, and 212 is a refuse-derived fuel material greatly reduced in size, weight, water content, and overall environmental impact. The refuse-derived fuel material is described as a fuzz or fluff, similar to pet bedding, cotton, blown-in insulation, or spill absorbent. The resulting refuse-derived fuel material is reduced in volume by up to 80%, and in weight by up to 50%, yet retains its full calorific value such that it may be used as a renewable energy source. For example, after the refuse-derived fuel material has cooled, it may be discharged into a separate holding cell, where it may then be pelletized, compressed into bricks or bales for easier storage, or vacuum-packed-and-sealed, depending on its future use, thereby further reducing its environmental impact size. The resulting product may replace fossil fuels in traditional power plants that produce electricity, or may be used in cement kilns, gasification modules, or pyrolysis plants. Method 200 achieves recycling mandates and renders the plurality of cannabis-related waste materials into a renewable energy source in a clean and effective manner, beyond that which is required by state regulations.

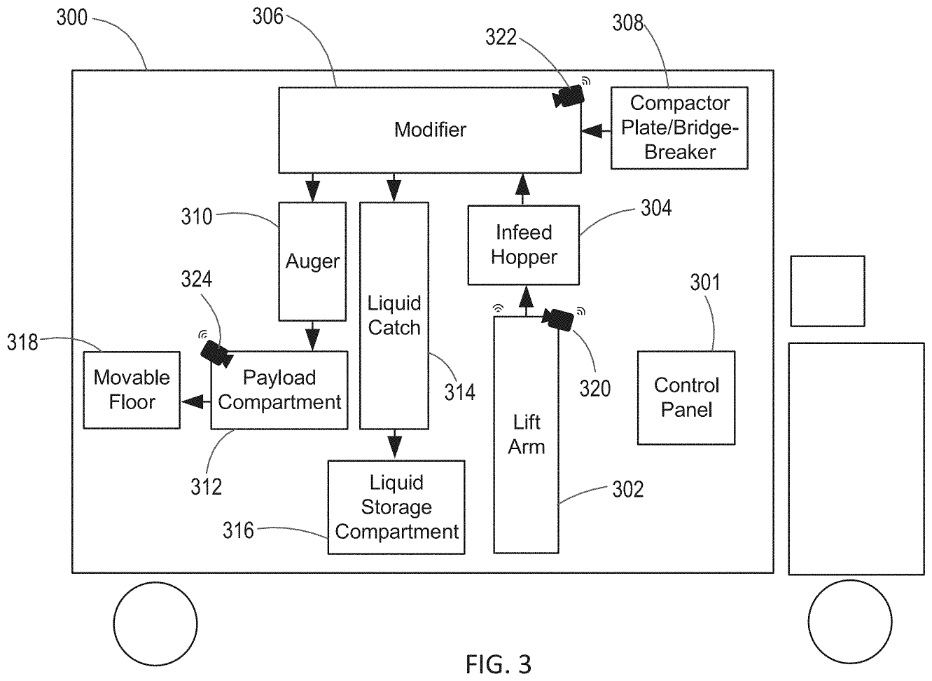

Referring now to FIG. 3, mobile rendering vehicle 300 for rendering cannabis-related waste materials, e.g., feedstock, is provided. Mobile rendering vehicle 300, e.g., an Automated Rendering Vehicle (ARV), is a state-of-the-art, mobile destruct truck, customized specifically to meet cannabis industry needs. Mobile rendering vehicle 300 may be equipped with a high-powered, on-board shredder, and is capable of processing a wide range of materials down to, e.g., a ¼-inch in size, or smaller. Mobile rendering vehicle 300 is both clean and efficient, and non-intrusive and secure. Moreover, to meet and exceed State Regulatory Requirements, e.g., Title 16 CCR, Division 42 “Bureau of Cannabis Control (BCC),” and Title 17 CCR, Division 1 “Manufactured Cannabis Safety Branch,” strategically positioned in-vehicle cameras may capture the entire rendering process to ensure compliance with local regulations.

As shown in FIG. 3, mobile rendering vehicle 300 may include control panel 301, lift arm 302, infeed hopper 304, modifier 306, compactor plate and/or bridge-breaker 308, auger 310, payload compartment 312, liquid catch 314, liquid storage compartment 316, movable floor 318, and a plurality of cameras, e.g., cameras 320, 322, 324. Control panel 301 may include a graphical user interface configured to receive user input, such that the user may start/stop operation of mobile rendering vehicle 300, and/or adjust one or more parameters of mobile rendering vehicle 300. For example, the user may adjust via control panel 301 infeed hopper speed and/or shredder speed. In addition, control panel 301 may have programmed parameter settings selectable based on the cannabis-related waste materials type. For example, the user may select a specific operation mode based on whether the cannabis-related waste materials includes plant material/light debris, dry edible goods, wet/tacky edible goods, hard material/bulky debris, etc. Accordingly, upon selection of the desired mode based on the cannabis-related waste materials type, mobile rendering vehicle 300 will properly render the feedstock, e.g., blend of cannabis-related waste materials, unrecognizable and unusable. Control panel 301 may be positioned on mobile rendering vehicle 300 in an easily accessible area, e.g., on an exterior side of mobile rendering vehicle 300, and may include a cover to protect control panel 301 when not in use. Additionally, control panel 301 may be actuated to process and print records of the rendering as proof of compliance.

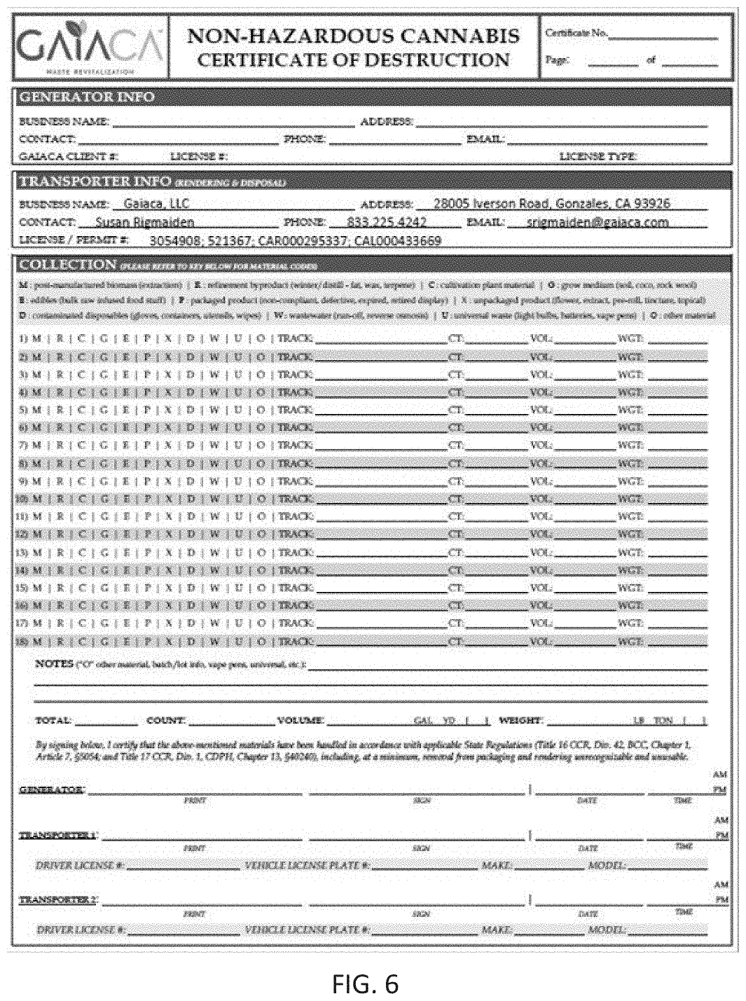

Lift arm 302 may be positioned along an exterior side of mobile rendering vehicle 300 for hoisting the blend into infeed hopper 304. The blend of cannabis-related waste materials may be contained within a receptacle bin, and lift arm 302 may releasably engage with the receptacle to hoist the receptacle, e.g., via a chain driven lift, from the ground toward and into infeed hopper 304. For example, lift arm 302 may have a plurality of grasping arms, e.g., hydraulic clamp, that transition between an open and closed configuration, such that, in the closed configuration, the receptacle is securely engaged with lift arm 302. Moreover, lift arm 302 may be operatively coupled to an electronic scale for measuring the weight of the blend in the receptacle. The scale may transmit, e.g., wirelessly via WiFi or Bluetooth technology, data indicative of the weight of the blend to a receiver, e.g., for efficient integration with shipping documents, as described in further detail with regarding to FIG. 6. In addition, camera 320 may be disposed on lift 302 to capture image data of lift arm 302 hoisting the receptacle/feedstock into infeed hopper 304 to ensure that the feedstock is properly inserted into mobile rendering vehicle 300. Camera 320 may also capture image data of personnel operating control panel 301 to verify proper personnel presence and use of control panel 301.

Infeed hopper 304 is sized and shaped to receive at least a portion of the receptacle hoisted by lift arm 302, such that the blend within the receptacle may be received within the interior of mobile rendering vehicle 300, e.g., in a feedstock compartment containing modifier 306. For example, a railing used to by lift arm 302 to hoist the receptacle vertically along mobile rendering vehicle 300 may extend through infeed hopper 304 into the feedstock compartment. Moreover, infeed hopper 304 may have a plurality of flexible covers that protect the feedstock compartment from external elements, and permit lift arm 302 holding the receptacle to move therethrough into the feedstock compartment.

Modifier 306 may physically alter the blend to render the blend unusable and unrecognizable in the manner described herein. For example, modifier 306 may be a shredder that utilizes a high-speed cutting rotor and metal teeth, e.g., stainless steel, to pulverize and process the blend. The shredder may be composed of strategically positioned stainless steel teeth on a rotating shaft that cuts against a stationary knife edge. The shredder may include a synthetic material lining for preventing corrosion of the metal teeth of the shredder. Moreover, mobile rendering vehicle 300 may include one or more guides 308, e.g., a compactor plate and/or a bridge-breaker, disposed within the feedstock compartment for guiding the blend towards the shredder. For example, a compactor plate may be used to guide/move the blend into the shredder on a two-dimensional plane, and a bridge-breaker may be used to guide/move the blend into the shredder on a three-dimensional plane, e.g., from top to bottom within the feedstock compartment. In addition, camera 322 may be disposed within the feedstock compartment to capture image data of the shredder pulverizing the blend to ensure that the blend within the feedstock compartment is properly moved into modifier 306. Alternatively, modifier 306 may be a compartment for physically altering the blend via saturation with a liquid as described above. For example, modifier 306 may receive the blend and apply a liquid to the blend to render the blend unrecognizable and unusable.

Payload compartment 312 may be sized and shaped to receive the pulverized blend from modifier 306, e.g., via gravity. In addition, auger 310 may be used to facilitate movement of the pulverized blend from modifier 306 to payload compartment 312. For example, auger 310 may be a rotatable spiral structure that guides the pulverized blend to payload compartment 312 as auger 310 is rotated. In addition, camera 324 may be disposed within payload compartment 312 to capture image data of the pulverized blend entering payload compartment 312 to ensure that the blend is properly pulverized. Alternatively or additionally, payload compartment 312 may have a reduced sized such that mobile rendering vehicle 300 further includes a cargo area for storage of containers and other equipment and supplies. The cargo area may have a side-mounted lift-gate for easy loading and unloading.

Optional liquid catch 314 and liquid storage compartment 316 may be used to separate and store liquids present in the blend from modifier 306. For example, liquid catch 314 may be positioned underneath modifier 306, and formed of a mesh material having pores large enough to permit liquid to flow therethrough, but small enough to prevent particles of the pulverized blend from passing through. The liquid flowing through liquid catch 314 will be directed to and stored within liquid storage compartment 316. For example, liquid storage compartment 316 may be an onboard storage tank or an awaiting drum fluidly coupled to liquid catch 314 via a hose.

Movable floor 318 may be, e.g., a conveyor belt, for moving the pulverized blend from payload compartment 312 out of mobile rendering vehicle 300. Accordingly, upon arrival at solid-waste facility, movable floor 318, may push processed feedstock out of mobile rendering vehicle 300. As shown in FIG. 3, cameras 320, 322, 324 may transmit image data to, e.g., a cloud-based server, via a wireless connection, e.g., internet, WiFi or Bluetooth connection, for video sharing to ensure proper receipt and pulverization of the blend.

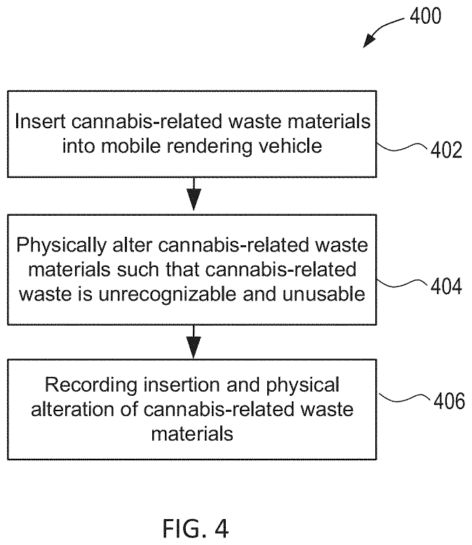

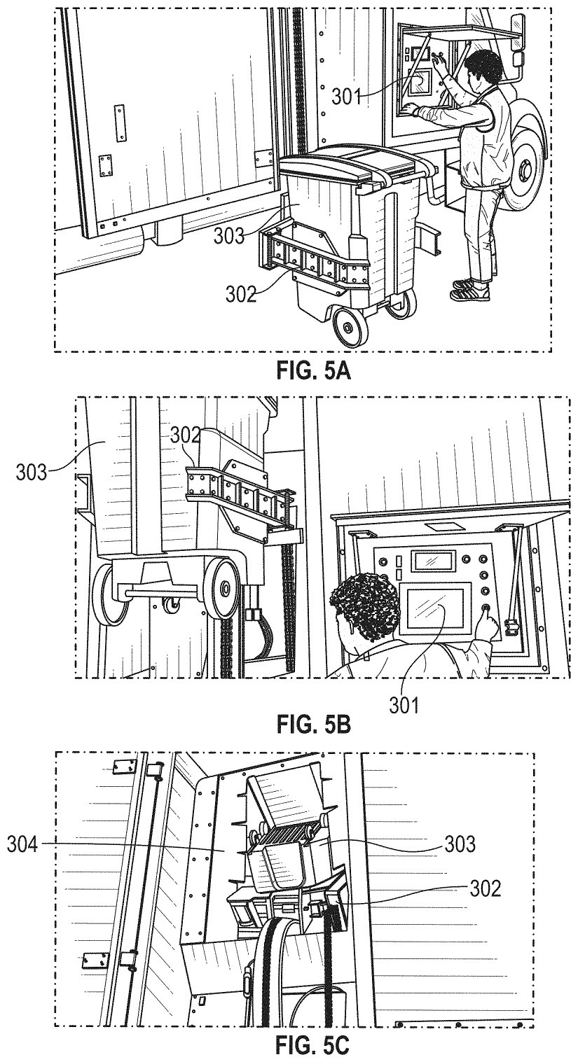

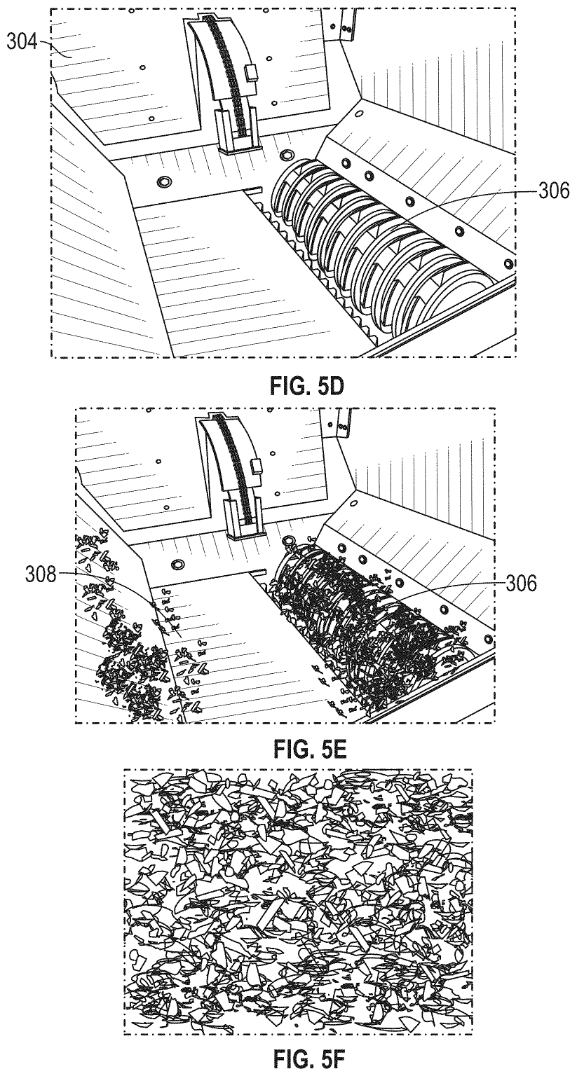

Referring now to FIG. 4, exemplary method 400 for rendering cannabis-related waste materials via mobile rendering vehicle 300 is described. Some of the steps of method 400 may be further elaborated by referring to FIGS. 5A to 5F. At step 402, a plurality of cannabis-related waste materials may be inserted into mobile rendering vehicle 300 via lift arm 302 and infeed hopper 304 as described above. As shown in FIG. 5A, mobile rendering vehicle 300 may be transported to an onsite location at a licensed premise, e.g., lawful property used/owned by a licensed distributor of cannabis-related products having cannabis-related waste materials to be disposed of.

Upon arrival, mobile rendering vehicle 300 may be parked in the designated Temporary Staging Area at the onsite location. The user/personnel may access the waste storage area at the onsite location, and a clear path of travel to the Temporary Staging Area. The user/personnel may then collect and relocate the receptacle bin(s) containing the cannabis-related waste materials from the waste storage area to the Temporary Staging Area, in preparation for destruction. The receptacle may be engaged by lift arm 302 as shown in FIG. 5A. The user/personnel may operate mobile rendering vehicle 300 via control panel 301 and select, e.g., start/stop, infeed hopper speed, shredder speed, and/or a preselected mode based on cannabis-related waste materials type. As shown in FIG. 5B, upon actuation of mobile rendering vehicle 300 via control panel 301, lift arm 302 hoists the receptacle upward toward infeed hopper 304. FIG. 5C shows lift arm 302 moving the receptacle into infeed hopper 304. The interior of the feedstock compartment having modifier 306 therein for receiving the cannabis-related waste materials from the receptacle is shown in FIG. 5D.

At step 404, the cannabis-related waste materials are physically altered, e.g., pulverized via modifier 306, as shown for example in FIG. 5E, until the cannabis-related waste materials are unrecognizable and unusable, as shown for example in FIG. 5F. Additionally or alternatively, the cannabis-related waste materials may be physically altered prior to introduction into mobile rendering vehicle 300. For example, a solution, e.g., a dye, may be applied to the cannabis-related waste materials to render it unrecognizable and unusable. Mobile rendering vehicle 300 may accept the unrecognizable and unusable cannabis-related waste materials for disposal.

In the example where mobile rendering vehicle 300 includes a shredder, compactor plate and/or bridge-breaker 308 may guide the cannabis-related waste materials into the shredder. The cannabis-related waste materials may remain in the feedstock compartment and be pulverized by the shredder until it has reached a pre-specified particle size, e.g., small enough to pass through a steel screen. Insertion of the cannabis-related waste materials into mobile rendering vehicle 300 as well as pulverization of the cannabis-related waste materials via the shredder may be recorded via strategically placed cameras, e.g., cameras 320, 322, at step 406, which may occur simultaneously with steps 402 and 404. Moreover, as described above, additional cameras, e.g., camera 324, may record additional parts of the rendering process such as when the pulverized cannabis-related waste materials enter payload compartment 312 for verification that the cannabis-related waste materials have been properly pulverized. The image data recorded may be transmitted, e.g., to a cloud-based server, for video sharing to ensure that the cannabis-related waste materials are properly received and pulverized by mobile rendering vehicle 300 to an unrecognizable and unusable state in compliance with local regulations.

After the cannabis-related waste materials are pulverized at the onsite location, mobile rendering vehicle 300 having the pulverized cannabis-related waste materials stored therein may be transported offsite to another location different from the licensed premise for disposal, and/or for further treatment as described above. For example, the pulverized cannabis-related waste materials may be transported to a facility where the pulverized cannabis-related waste materials are offloaded from mobile rendering vehicle 300, e.g., via moving floor 318, and may be heated to sterilize/denature the pulverized cannabis-related waste materials, have any remaining liquid evaporated therefrom, and cooled to form a refuse-derived fuel.

Referring now to FIG. 6, a sample Certificate of Destruction is described. The user/personnel of the Transporter may generate a Certificate of Destruction documenting container/receptacle bin information, as well as verifying any supporting documents provided by the Client/Generator, e.g., a licensed distributor/retailer of cannabis-related products having cannabis-related waste materials to be disposed of. For example, the Certificate of Destruction may include Client/Generator information including business name, address, contact name, phone number, email, a client ID number allocated to the specific Client/Generator by the Transporter, and the Client/Generator's license number and type. The Client/Generator information may be entered, e.g., via the graphical user interface of control panel 301 on an electronic fillable/printable form integrated with control panel 301, beforehand on an electronic fillable/printable form via a computing device, or manually on a printed form at the onsite location. The Certificate of Destruction further may include Transporter information, e.g., of the user/personnel, including, for example, business name, address, contact name, phone number, email, the Transporter's license/permit number. The Transporter information may be auto-populated beforehand, or filled out manually at the onsite location.

Moreover, the Certificate of Destruction further may include Collection information, e.g., information regarding the cannabis-related waste materials to be disposed of. As shown in FIG. 6, the different types of cannabis-related waste materials to be collected/pulverized may be reduced to an easily understood code, e.g., letter, and the decipher key may be displayed on the Certificate of Destruction for efficient reference. For example, the Collection information codes may include M: post-manufactured biomass (extraction); R: refinement byproduct (winter/distill—fat, wax, terpene; C: cultivation plant material; G: grow medium (soil, coco, rock wool); E: edibles (bulk raw infused food stuff); P: packaged product (non-compliant, defective, expired, retired display); X: unpackaged product (flower, extract, pre-roll, tincture, topical); D: contaminated disposables (gloves, containers, utensils, wipes); WI: wastewater (run-off, reverse osmosis); U: universal waste (light bulbs, batteries, vape pens); 0: other materials. As will be understood by a person ordinarily skilled in the art, different codes/letters may be used, and/or additional types of Collection information may be utilized on the Certificate of Destruction. Accordingly, each container/receptacle bin of cannabis-related waste materials collected at the onsite location may be allocated a numerical number, and for each container/receptacle bin, the coded letter identifying the Collection information may be marked, e.g., circled. As many coded letters as necessary may be marked to accurately indicate what types of cannabis-related waste materials are present within the container/receptacle bin. If “0” is marked indicating “other materials” are present in the cannabis-related waste materials, more information regarding the materials may be inputted under “NOTES.”

Additionally, track, count, volume, and weight information for each container/receptacle bin may be provided. Accordingly, the user/personnel may perform a visual assessment of the container/receptacle bin and the contents therein to document volume and physical description of the cannabis-related waste materials. Moreover, as described above, data indicative of the weight of the cannabis-related waste materials to be destructed/pulverized within each container/receptacle bin may be electronically received from an electronic scale operatively coupled to lift arm 302, e.g., wirelessly via WiFi or Bluetooth technology, and automatically filled into the appropriate entry on the Certificate of Destruction. Alternatively or additionally, the cannabis-related waste materials to be destructed/pulverized may be weighed manually using a separate scale.

The sum/totals of all the containers/receptacle bins may be calculated and inputted under the total, count, volume, weight section underneath the NOTES section. Upon completion of the Certificate of Destruction, the Client/Generator as well as the user/personnel of the Transporter may print their name(s), sign, date, and time the Certificate of Destruction. Additionally, the user/personnel of the Transporter may include additional information including their driver license number, vehicle license plate number, and make and model of the vehicle, e.g., the mobile rendering vehicle.

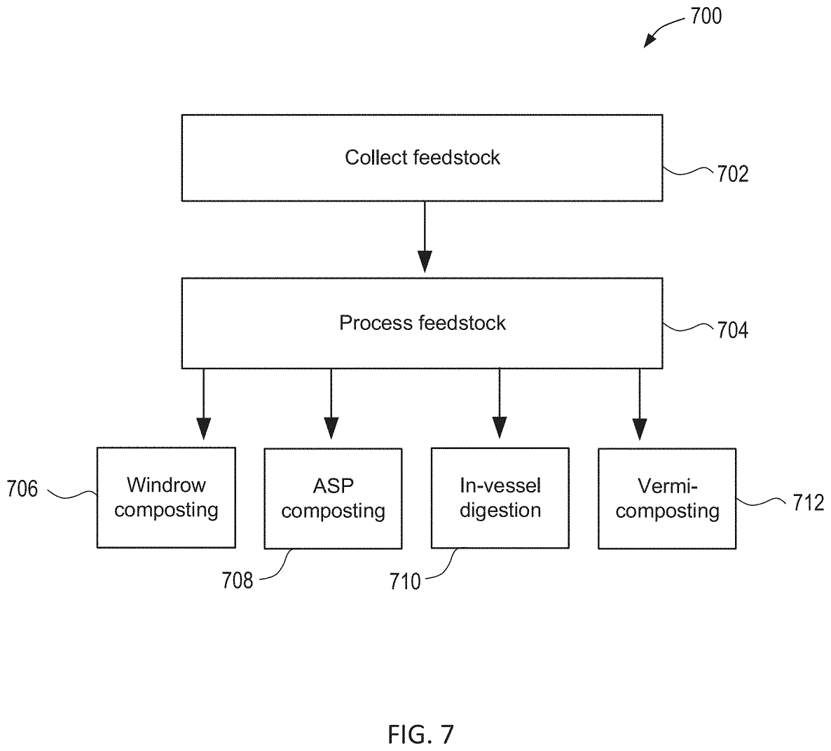

Referring now to FIG. 7, exemplary method 700 for rendering cannabis-related waste materials into compost is provided. At step 702, feedstock may be collected for composting. As described above, as cannabis waste is rich in both nitrogen-rich “green” material and carbon-rich “brown” material, it may be suitable feedstock for composting. For example, the stalks and roots of the cannabis plant as well as the grow medium used to cultivate the cannabis plant are rich in carbon, and the leaves and flower of the cannabis plant as well as the biomass are rich in nitrogen. Other cannabis-related waste materials that may be suitable feedstock for composting include consumable goods such as food products, edibles, beverages, pre-rolls, flower, extracts, concentrates, tinctures, topicals, and empty product packaging. In addition, organic byproducts produced during cannabis cultivation and manufacturing may be suitable feedstock for composting including, for example, paper byproducts, cardboard byproducts, refuse, food materials, etc.

The cannabis-related feedstock may be collected from, e.g., cannabis operators such as testing labs, distributors, dispensaries, microbusinesses, cannabis cultivators, nurseries, processors, and manufacturers of cannabis products. For example, cannabis waste is accumulated by generators such as licensed commercial cannabis businesses in containers ranging from, e.g., 5 gallons to 40 cubic yards. During collection, waste streams may be source separated for more efficient processing. The cannabis waste should be collected from generators by specially trained and licensed individuals, such that the waste collection may be documented, and track-and-traced to meet State requirements, as described above. The cannabis waste may then be transported to for processing via, e.g., box, side-load, or roll-off style trucks.

Additional feedstock may be collected that may be composted with the cannabis-related feedstock such as, for example, organic materials, yard waste, landscaping debris, newspaper/paper products, cardboard, fiber, foods (fruits, vegetables, grains, breads, nuts, eggshells, coffee/tea, seaweed, etc.), agricultural processing waste, animal and plant materials, manure, biosolids, solid waste, mushroom mycelium, grape pomace, etc.

At step 704, the collected feedstock may be processed in preparation for composting. For example, inbound waste materials may be sorted and separated into organics (suitable for composting) and inorganics (unsuitable for composting). The organics may be diverted to the compost area for further processing, while the inorganics (e.g., plastic, metal, glass, disposable items such as gloves, containers, and utensils, hazardous chemicals, vape cartridges, batteries, lamps/lights, etc.) may be diverted to a partner facility for further treatment, recycling, and/or landfill disposal. The organics may be mixed and blended to form a pre-compost blend to promote efficient composting. Obtaining the correct nutrient mix of the feedstock may be critical for composting. For example, the carbon to nitrogen ratio (C:N) may be 25-30:1, or 25-30 parts carbon for every 1 part nitrogen. As will be understood by a person having ordinary skill in the art, the desired feedstock may comprises a nutrient mix having other carbon to nitrogen ratios.

Once the right blend is determined, the feedstock materials may be ground, shredded, and pulverized using the methods described above, e.g., using either a high-powered horizontal belt-felt grinder or a high-powered tub-style grinder, which may be referred to as “chipping-and-grinding” to form a pre-compost blend, e.g., feedstock suitable for composting. Preferably, the feedstock materials are ground to a consistent, homogeneous particle size ranging from, e.g., 0.5 to 2 inches. Particles that are too small may restrict air flow during composting, and particles too large may slow decomposition and result in low temperatures and rot. Accordingly, the finished, processed pre-compost blend of feedstock materials may be a suitable feedstock for composting via, for example, windrow (turned), aerated static pile (ASP), in-vessel digestion, vermicomposting, or the Bokashi method as will be understood by a person having ordinary skill in the art, which may take anywhere from a few weeks to six months depending on the method used.

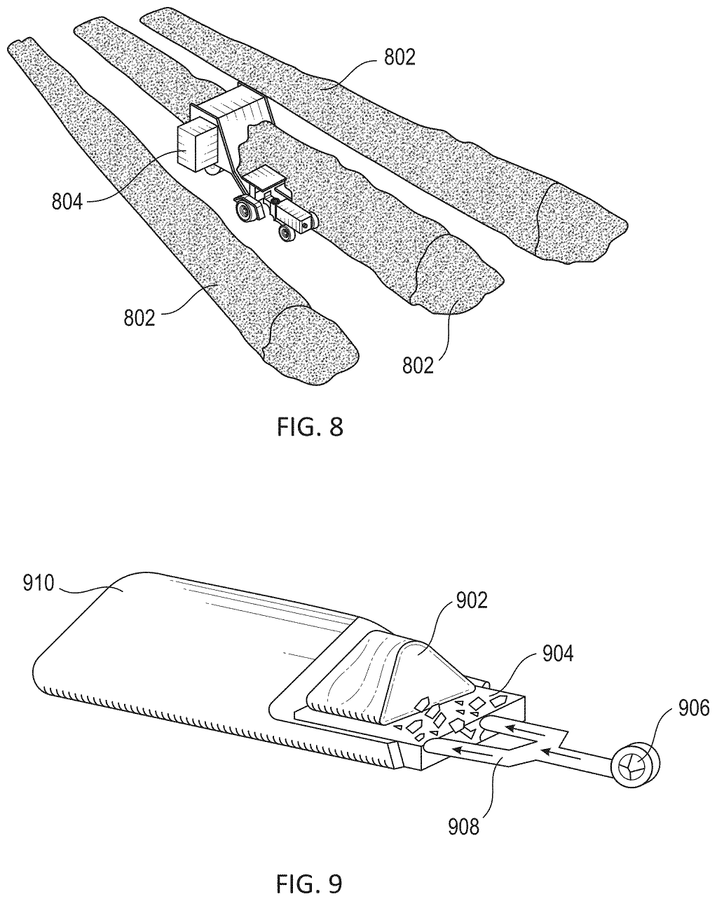

For example, as step 706, composting may be conduct via windrow, as shown in FIG. 8. Specifically, ground feedstock may laid out in rows, referred to as windrows. Windrows 802 may be placed indoors, partially covered, or outdoors. Each windrow may be, for example, 4 to 8 feet high, with a width of 14 to 16 feet, and may be arranged in a trapezoidal shape. The row size may be large enough to generate enough heat and maintain temperatures, yet small enough to allow oxygen flow to the windrow's core.

Moreover, the temperatures should be checked daily and may be recorded on a log sheet. For example, the temperatures may be checked utilizing an approximately 3 to 4 foot thermometer probe at intervals of roughly 150 feet along the windrow, or once for every 200 cubic-yards of compost. The temperature probe may be inserted within the windrow to a depth between 12 to 24 inches below the surface. Ideally, the temperature measured should be maintained between 135 to 160 degrees Fahrenheit. For example, if the temperature is too low, decomposition may stop, and/or the windrow may rot. Moreover, if the temperature is too high, the windrow may become anaerobic, and overheating may kill beneficial microbes. Overheating further may result in spontaneous combustion and fires. The temperature may be adjusted by, e.g., wetting the windrow to increase or decrease moisture content (MC) and/or turning or aerating the windrow to increase or decrease airflow.

The windrows should be turned, e.g., via mechanical rotating drum windrow turner 804, every 2 to 4 days, depending on the age of the windrow and the temperature. Turning introduces more oxygen, thereby promoting beneficial microbes and stopping pathogen growth. The MC of the windrow should be routinely monitored, e.g., visually and by touch. Water may be added to the windrow on an as-needed basis, e.g., whenever the MC drops below 50%. Preferably, the ideal MC is around 65%. Water may be added, e.g., by rotating drum windrow turner 804, by a water tanker truck, or manually by a hose.

As described above, the temperature should be checked and adjusted as necessary, the windrows should be turned, and the MC should be monitored and maintained for approximately 2 to 6 months, until the composting is complete. For example, in California, compost must undergo a pathogen reduction period where temperatures of 131 degrees Fahrenheit or higher are maintained for at least 15 days. Upon completion of windrow composting, the finished compost should be screened to remove contaminants such as plastic and metals, and to grade the compost for various end uses. Screening may be done, e.g., by a mechanical trommel, star, orbital, grizzly, or disc screen, or manually by a flat/deck screen. Any oversized materials may be removed and added back in subsequently laid windrows until they are composted down completely.

Alternatively, at step 708, composting may be conduct via aerated static pile (ASP), as shown in FIG. 9. An aerated static pile (ASP) compost system works similarly to a windrow composting system; however, without the need to turn the piles to provide oxygen. Instead, in an ASP compost system, oxygenation of the pile may be obtained, e.g., via blower manifold, rather than turning or agitation. Accordingly, the ASP compost site may be prepared by constructing a non-permeable pad, which may be indoors, partially covered, or outdoors. The pad may include a network of PVC pipes, e.g., manifold 908, therewithin. Manifold 908 should be perforated with holes to deliver air uniformly across the pad. Moreover, the manifold may be connected to a mechanical blower, e.g., fan 906, which may be activated manually, on a timer, or connected to a temperature sensor.

In addition, a 12 to 24 inch plenum layer, e.g., building agent 904, may be laid out on the pad, and active compost layer 902, may be laid out on top of the plenum layer, such that plenum layer 904 facilitates a uniform distribution of airflow from manifold 908 into active compost layer 902. Plenum layer 904 may include, for example, coarse material such as gravel or rocks, and active compost layer 902 may consist of the compost feedstock. The total size of the compost pile may depend on the size and structure of the ASP system. For example, the total size of a compost pile may range from 200 to 600 cubic yards, and may be trapezoidal in shape. Additionally, a 6 to 12 inch biofiltration layer, e.g., screened compost 910, may be laid out on top of active compost layer 902 to trap heat and odors, and protect the active compost layer (core) from unwanted vectors, e.g., birds, rodents, etc. Biofiltration layer 910 may include, for example, mulch, compost, or a specialized cover material.

The temperatures should be checked daily and may be recorded on a log sheet. For example, the temperatures shall be checked utilizing an approximately 3 to 4 foot thermometer probe at intervals of roughly 150 feet along the pile, or once for every 200 cubic-yards of compost. The temperature probe may be inserted within the pad to a depth between 12 to 18 inches from the point where the biofiltration layer (insulation) cover meets the active compost layer. Ideally, the temperature measured should be maintained between 135 to 160 degrees Fahrenheit. For example, if the temperature is too low, decomposition may stop, and/or the pad may rot. Moreover, if the temperature is too high, the windrow may become anaerobic, and overheating may kill beneficial microbes. Overheating further may result in spontaneous combustion and fires. The temperature may be adjusted by, e.g., wetting the windrow to increase or decrease MC and/or aerating the windrow to increase or decrease airflow.

As there is no physical turning, the ASP composting method requires careful monitoring to ensure that the outside of the pile heats up as much as the core. The MC of the pile should be routinely monitored, e.g., visually and by touch. Water may be added to the pile on an as-needed basis, e.g., whenever the MC drops below 50%. Preferably, the ideal MC is 65%. Water may be added, e.g., by overhead sprinklers or manually by a hose.

As described above, the temperature should be checked and adjusted as necessary, and the MC should be monitored and maintained for approximately 1 to 2 months, until the composting is complete. For example, in California, compost must undergo a pathogen reduction period where temperatures of 131 degrees Fahrenheit or higher are maintained for at least 3 days. Upon completion of ASP composting, the finished compost should be screened to remove contaminants such as plastic and metals, and to grade the compost for various end uses. Screening may be done, e.g., by a mechanical trommel, star, orbital, grizzly, or disc screen, or manually by a flat/deck screen. Any oversized materials may be removed and added back in subsequently laid active compost layers that are laid out on top of subsequently laid plenum layers until they are composted down completely.

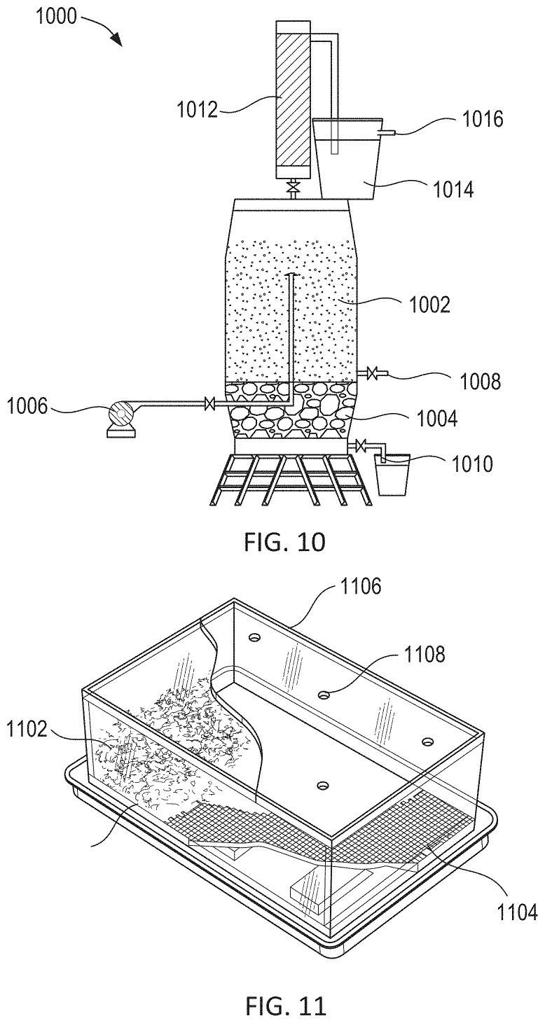

Alternatively, as step 710, composting may be conduct via in-vessel digestion, as shown in FIG. 10. For example, a vessel commonly referred to as a composting reactor may first be constructed or obtained. Composting reactor 1000 may be constructed in various shapes and sizes specific to the site and feedstock conditions, and may be indoors, partially covered, or outdoors. For example, the composting reactors may be constructed of, e.g., polyethylene plastic, concrete, or stainless or carbon steel, and may have a size ranging between 0.25 to 1,000 cubic yards. The composting reactors may contain complex microbial communities that break down (or digest) the waste in the absence of oxygen, e.g., via an anaerobic process. Moreover, the reactor may have sampling hole 1008, outlet 1010 at the base to allow for leachate drainage, as well as outlet 1016 at the top to allow for off-gassing of, e.g., biogas. For example, the biogas may be passed through a 2% solution of liquid boric acid 1014, and then subsequently collected via outlet 1016. In addition, composting reactor 1000 may have an aerator connected to a mechanical blower, e.g., air supply 1006, as well as an internal temperature sensor.

Next, plenum layer 1004 may be added to facilitate a uniform distribution of airflow and allow for proper drainage. For example, plenum layer 1004 may take up approximately 10% of the volume of composting reactor 1000. Plenum layer 1004 may include, for example, coarse material such as gravel or rocks. Active layer 1002 may then be added on top of plenum layer 1004, such that active layer 1002 fills up approximately 50% of the volume of composting reactor 1000, leaving 40% head space within the composting reactor. Active layer 1002 may consist of the compost feedstock.

The temperatures should be checked daily and may be recorded on a log sheet. For example, the temperatures may be checked via the internal temperature sensor. As described above, in California, for example, compost must undergo a pathogen reduction period where temperatures of 131 degrees Fahrenheit or higher are maintained for at least 3 days. In addition, leachate (digestate) may be drained as required via outlet 1010, and biogas may be captured as it is produced via outlet 1016.

As described above, the temperature should be checked and adjusted as necessary, leachate should be drained as required, and biogas should be captured as produced until digestion is complete, e.g., 3 to 12 weeks depending on the feedstock and system. Upon completing of digestion, the finished material (digestate) may be removed from the composting reactor and placed in a pile on a non-permeable surface to cure for an additional 3 to 4 weeks. Upon completion of curing, the cured digestate should be screened to remove contaminants such as plastic and metals, and to grade the material for various end uses. Screening may be done, e.g., by a mechanical trommel, star, orbital, grizzly, or disc screen, or manually by flat/deck screen. Any oversized materials may be removed and added back in subsequently laid active layers that are added on top of subsequently laid plenum layers until they are digested down completely. Additionally, captured biogas and leachate may require cleaning, filtering, and/or refining depending on the intended final use.

Alternatively, as step 712, composting may be conduct via vermicomposting, as shown in FIG. 11. For example, one or more bins 1106 may first be obtained. Bin 1106 may be opaque such that light does not enter the bin. Bin 1106 may be, e.g., approximately 15 inches in width, 25 inches in length, and 5 inches deep. As will be understood by a person having ordinary skill in the art, the bins may have various sizes suitable for composting. Bin 1106 may be prepared by creating one or more drainage/air circulation holes 1108 in the sides, top, and/or bottom of the bins. For example, each hole may be approximately ⅛ to 1 inch. Moreover, holes 1108 may be covered with screen material, e.g., mesh 1104. Next, bin 1106 may be placed in a larger bin configured to catch drainage, e.g., worm tea.

The bins should be placed in a cool, shady area, e.g., indoors, partially covered, or outdoors. Ideally, the temperature of where the bins are stored should be maintained between 55 to 77 degrees Fahrenheit. Materials 1102 such as shredded paper, newspaper, phone books, cardboard, toilet paper/paper towel tubes, and/or egg cartons may be used to prepare worm bedding. However, glossy paper should be avoided. The worm bedding should be kept moist at all times.

Next, the feedstock may be added to the bin, such that the feedstock fills up approximately half of the bin. The feedstock will start to compost, thereby creating a beneficial environment for the worms. Worms may then be added to the feedstock, which will consume the microbes that break down the feedstock. For example, Eisenia Fetid or red worms are preferred. However, earthworms should not be used in the bins. The bins should be continually fed with feedstock, while being careful not to overload the bins with feedstock. Moreover, the bedding should be replenished upon each feeding event, and the continually moistened. The bins should be continually fed with feedstock and the bedding replenished and moistened for, e.g., approximately 3 to 4 months, until usable castings are created.

Worm casting harvest bins may be prepared. For example, the bins may have lids with, e.g., half inch holes. The contents of the compost bins may then be transferred onto the tops of the harvest bins, and the harvest bins may be placed in direct sunlight. The sunlight will cause the worms to burrow through the holes in the lid, down into the harvest bin, effectively separating the worms from the castings. Upon completion, the castings may be harvested. Any drainage, e.g., worm tea, that has been formed should also be harvested. The worms may then be returned to the compost bins such that the vermicomposting process may be repeated, e.g., feeding the bins with feedstock and replenishing the bedding until usable castings are created, and harvesting the castings.

Accordingly, as a result of one or more of the composting procedures described above, final end-products may include, for example, a compost (humus) such as Cannabis Compost™ (made available by Grow Depot LLC, Gonzales, Calif.), cannabis digestate (solid), worm castings (solid), cannabis leachate (liquid), worm tea (liquid), and/or biogas, e.g., CH4, CO2, and/or H2O. The resultant compost may be used on its own as a nutrient-rich fertilizer or as a soil amendment, or alternatively, may be used to produce compost tea (liquid fertilizer). For example, one or more organic bulking agents may be added to the resultant compost to create a finished soil product, e.g., green waste, soil, etc. Organic bulking agents may include, for example, at least one of organic materials, yard waste, landscaping debris, newspaper, paper products, cardboard, fiber, foods, agricultural processing waste, animal and plant materials, manure, biosolids, solid waste, mushroom mycelium, or grape pomace.

Cannabis digestate may be used as a nutrient-rich fertilizer, as animal bedding, to make building materials, irrigate crops, or as a feedstock to create horticulture products such as soil amendments, peat moss replacement, and/or plant pots. Cannabis leachate may be mixed with water and used as a nutrient-rich liquid fertilizer. Biogas may be used to produce electricity, heat, vehicle fuel, or renewal natural gas, or may be used as a feedstock to produce bioproducts such as bioplastics. Worm castings may be used on its own as a nutrient-rich fertilizer or as a soil amendment. Worm tea may be mixed with water and used as a nutrient-rich liquid fertilizer.

While various illustrative embodiments of the invention are described above, it will be apparent to one skilled in the art that various changes and modifications may be made therein without departing from the invention. The appended claims are intended to cover all such changes and modifications that fall within the true scope of the invention.

What is claimed:

1. A method for composting cannabis-related waste materials, the method comprising:
obtaining a plurality of cannabis-related waste materials;
physically altering the plurality of cannabis-related waste materials to form a pre-compost blend, such that the physically altered cannabis-related waste materials are altered to smaller particle sizes suitable as a pre-compost; and
transforming the pre-compost blend into compost.

2. The method of claim 1, wherein obtaining the plurality of cannabis-related waste materials comprises obtaining a mix of cannabis-related waste materials comprising a predetermined ratio of carbon to nitrogen.

3. The method of claim 2, wherein the predetermined ratio of carbon to nitrogen is 25-30:1.

4. The method of claim 1, wherein the plurality of cannabis-related waste materials comprises at least one of cannabis plant material, cannabis-infused products, mixed packaging, manufacturing byproducts, grow medium, or contaminated disposables.

5. The method of claim 1, wherein physically altering the plurality of cannabis-related waste materials comprises pulverizing the plurality of cannabis-related waste materials.

6. The method of claim 1, wherein transforming the pre-compost blend into compost comprises transforming the pre-compost blend into compost via a windrow method.

7. The method of claim 6, wherein the windrow method comprises:
laying the pre-compost blend in one or more rows sized and shaped to generate sufficient heat and facilitate maintenance of a temperature within a predetermined range, while permitting oxygen to flow to a core of the one or more rows of pre-compost blend; and
increasing a moisture content of the one or more rows of pre-compost blend and/or turning the one or more rows of pre-compost blend to maintain the temperature within the predetermined range over a predetermined period of time to transform the one or more rows of pre-compost blend into compost.

8. The method of claim 1, wherein transforming the pre-compost blend into compost comprises transforming the pre-compost blend into compost via an aerated static pile (ASP) method.

9. The method of claim 8, wherein the ASP method comprises:
laying a plenum layer of coarse material on a non-permeable pad, the pad comprising a perforated manifold configured to deliver air uniformly across the pad;
laying the pre-compost blend on top of the plenum layer;
laying a biofiltration layer on top of the pre-compost blend to facilitate maintenance of a temperature within a predetermined range; and
increasing a moisture content of the pre-compost blend and/or aerating the pre-compost blend via the manifold to maintain the temperature within the predetermined range over a predetermined period of time to transform pre-compost blend into compost.

10. The method of claim 1, wherein transforming the pre-compost blend into compost comprises transforming the pre-compost blend into compost via in-vessel digestion.

11. The method of claim 10, wherein in-vessel digestion comprises:
adding a plenum layer of coarse material within a composting reactor comprising complex microbial communities adapted to digest the pre-compost blend via an anaerobic process, the plenum layer configured to facilitate uniform distribution of airflow and proper drainage of the composting reactor;
adding the pre-compost blend on top of the plenum layer within the composting reactor, such that there is a predetermined amount of head space within the composting reactor;
maintaining a temperature within a predetermined range over a first predetermined period of time until the complex microbial communities transform the pre-compost blend into a digestate; and
curing the digestate for a second predetermined period of time to transform the digestate into compost.

12. The method of claim 11, wherein the compost is configured to be used as a nutrient-rich fertilizer, as animal bedding, to make building materials, irrigate crops, or as a feedstock to create horticulture products comprising at least one of soil amendments, peat moss replacement, or plant pots.

13. The method of claim 11, further comprising:
draining leachate from the composting reactor,
wherein the leachate is configured to be mixed with water and used as a nutrient-rich liquid fertilizer.

14. The method of claim 11, further comprising:
capturing biogas from the composting reactor,
wherein the biogas is configured to be used to produce electricity, heat, vehicle fuel, or renewal natural gas, or as a feedstock to produce bioproducts.

15. The method of claim 14, further comprising passing the biogas through a solution of liquid boric acid prior to capturing the biogas from the composting reactor.

16. The method of claim 1, wherein transforming the pre-compost blend into compost comprises transforming the pre-compost blend into compost via vermicomposting.

17. The method of claim 16, wherein vermicomposting comprises:
preparing worm bedding within an opaque bin comprising one or more holes, the one or more holes covered with a screen material;
adding the pre-compost blend to the opaque bin;
adding worms to the pre-compost blend, such that the worms are adapted to consume microbes that break down the pre-compost blend and create compostable castings; and
continually replenishing the worm bedding and keeping the worm bedding moist for a predetermined period of time to transform the pre-compost blend into compostable castings.

18. The method of claim 17, wherein the compostable castings are configured to be used as a nutrient-rich fertilizer or a soil amendment.

19. The method of claim 17, further comprising:
draining worm tea from opaque bin,
wherein the worm tea is configured to be mixed with water and used as a nutrient-rich liquid fertilizer.

20. The method of claim 17, further comprising:
transferring contents within the opaque bin on top of a lid of a harvest bin, the lid comprising one or more holes;
placing the harvest bin in direct sunlight, thereby causing the worms to burrow through the one or more holes into the harvest bin; and
harvesting the compostable castings from the contents on top of the lid of the harvest bin.

21. The method of claim 1, wherein the compost is configured to be used as a nutrient-rich fertilizer or a soil amendment.

22. The method of claim 1, further comprising:
obtaining one or more additional feedstock materials; and
blending the one or more additional feedstock materials with the plurality of cannabis-related waste materials to form a feedstock blend,
wherein physically altering the plurality of cannabis-related waste materials to form the pre-compost blend comprises physically altering the feedstock blend, such that the physically altered cannabis-related waste and one or more additional feedstock materials are altered to smaller particle sizes suitable as a pre-compost.

23. The method of claim 22, wherein the one or more additional feedstock materials comprises at least one of organic materials, yard waste, landscaping debris, newspaper, paper products, cardboard, fiber, foods, agricultural processing waste, animal and plant materials, manure, biosolids, solid waste, mushroom mycelium, or grape pomace.

24. The method of claim 23, wherein the foods comprise at least one of fruits, vegetables, grains, breads, nuts, eggshells, coffee, tea, or seaweed.

25. The method of claim 1, further comprising:
separating the obtained plurality of cannabis-related waste materials into compostable organics and non-compostable inorganics,
wherein physically altering the plurality of cannabis-related waste materials to form the pre-compost blend comprises physically altering the compostable organics to form the pre-compost blend.

26. The method of claim 25, further comprising treating, recycling, or disposing the non-compostable inorganics.

27. The method of claim 25, wherein the non-compostable inorganics comprise at least one of plastic, metal, glass, gloves, containers, utensils, hazardous chemicals, vape cartridges, batteries, lamps, or lights.

28. The method of claim 25, further comprising screening the compost via at least one of a mechanical trommel, star, orbital, grizzly, disc screen, or flat/deck screen.

29. The method of claim 1, wherein physically altering the plurality of cannabis-related waste materials to form the pre-compost blend comprises physically altering the plurality of cannabis-related waste materials such that the physically altered cannabis-related waste materials are unrecognizable and unusable.

30. The method of claim 1, further comprising adding one or more organic bulking agents to the compost to form a finished soil product.
